(19) United States
(12) Patent Application Publication
(10) Pub. No.: US 2016/0059898 A1
(43) Pub. Date: Mar. 3, 2016

(54) LOCATOR CAM ASSEMBLY

(71) Applicant: GM GLOBAL TECHNOLOGY OPERATIONS LLC, Detroit, MI (US)

(72) Inventor: Allyn R. MacKay, Grosse Pointe, MI (US)

(21) Appl. No.: 14/469,762

(22) Filed: Aug. 27, 2014

(51) Int. Cl. B62D 25/12

(52) U.S. Cl. CPC B62D 25/12

(57) ABSTRACT

A locator cam assembly can adjust the position of one component with respect to another component. In an embodiment, the locator cam assembly includes a retainer having a retainer body. The retainer defines a retainer opening extending through the retainer body. The locator cam assembly further includes a locating pin having a head and a shank extending from the head. The head defines a head center and the shank extends along a shank axis. The shank axis is offset from the head center.

### TECHNICAL FIELD

The present disclosure relates to a locator cam assembly for adjusting the position of one component relative to another component.

### BACKGROUND

During a vehicle assembly process, a vehicle component sometimes must be aligned with another vehicle component. For instance, vehicle components may be manually aligned with each other before securing the vehicle components together. Alternatively, a tool can be used to align one vehicle component with another vehicle component.

### SUMMARY

It is useful to develop an assembly capable of moving one component in order to align that component with another component. The present disclosure describes a locator cam assembly capable of adjusting the position of one component with respect to another component. In an embodiment, the locator cam assembly includes a retainer having a retainer body. The retainer defines a retainer opening extending through the retainer body along a retainer axis. The locator cam assembly further includes a locating pin having a head and a shank extending from the head. The head defines a head center, and the shank extends along a shank axis. The shank axis is offset from the head center.

The present disclosure also describes a component assembly including the locator cam assembly described above. In addition to the locator cam assembly, the component assembly includes a first component defining a component hole and a second component defining a component slot. The retainer body of the retainer extends through the component hole such that the retainer is coupled to the first component. The head of the locating pin is disposed in the component slot. The locating pin can rotate about the shank axis relative to the retainer such that the rotation of the locating pin causes the first component to move relative to the second component. The present disclosure also relates to a vehicle including the component assembly described above.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic, perspective view of a locator cam assembly including a retainer and a locating pin;

FIG. 2 is a schematic, perspective view of the retainer shown in FIG. 1;

FIG. 3 is a schematic, perspective view of the locating pin shown in FIG. 1;

FIG. 4 is a schematic, cross-sectional side view of the locator cam assembly coupled between two components shown in FIG. 1;

FIG. 5 is a schematic, perspective bottom view of the locator cam assembly coupled to a component;

FIG. 6 is a schematic, perspective top view of the locator cam assembly coupled to the component shown in FIG. 5;

FIG. 7 is a schematic, front view of the locator cam assembly coupled between two components, wherein the locating pin of the locator cam assembly is in a first position;

FIG. 8 is a schematic, front view of the locator cam assembly coupled between two components, wherein the locating pin of the locator cam assembly is in a second position; and

FIG. 9 is a schematic, front view of the locator cam assembly coupled between two components, wherein the locating pin of the locator cam assembly is in a third position.

### DETAILED DESCRIPTION

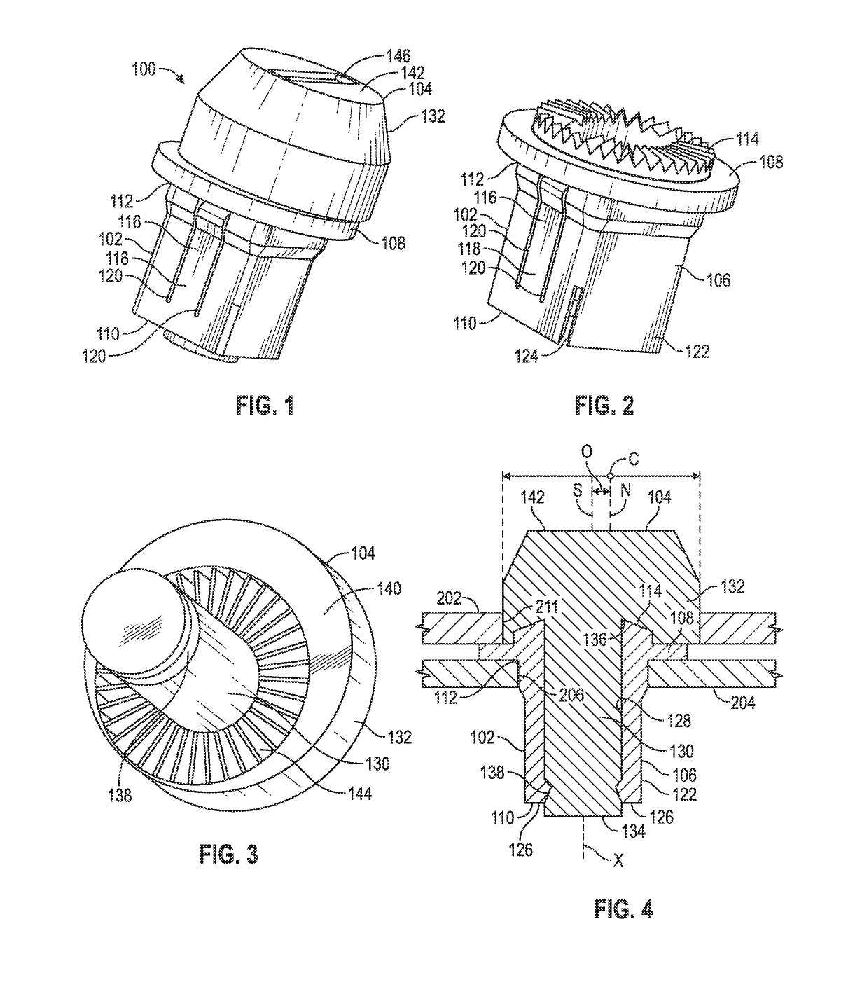

Referring to the drawings, wherein like reference numbers correspond to like or similar components throughout the several figures, and beginning with FIGS. 1-4, a locator cam assembly 100 can be used to adjust the position of a first component 202 (FIG. 7) relative to a second component 204 (FIG. 7). The locator cam assembly 100 includes a retainer 102 and a locating pin 104. The retainer 102 can hold the locating pin 104 and can be coupled to the second component 204. The first component 202 and the second component 204 may be vehicular components and are part of a component assembly 201 (FIG. 7). The component assembly 201 may in turn be part of a vehicle 200 (FIG. 7), such as a car or truck. In the depicted embodiment, the retainer 102 is wholly or partly made of a resilient material, such as a resilient polymer. However, the retainer 102 may be made of any other suitable resilient material, such as a resilient metal.

With specific reference to FIG. 2, the retainer 102 is substantially hollow and includes a retainer body 106 and a retainer base 108 coupled to the retainer body 106. The retainer body 106 may have a substantially rectangular cross-section and defines a first body end 110 and a second body end 112 opposite the first body end 110. The retainer base 108 is coupled to the retainer body 106 at the second body end 112.

In the depicted embodiment, the retainer base 108 has a substantially annular shape. It is contemplated, however, that the retainer base 108 may have other suitable shapes. For instance, the retainer base 108 may have a substantially rectangular shape. Irrespective of its shape, the retainer base 108 can support at least a portion of the locating pin 104.

The retainer 102 additionally includes a plurality of retainer protrusions 114 extending from the retainer base 108 away from the retainer body 106. The retainer protrusions 114 are annularly arranged around a retainer axis X (FIG. 4). Further, the retainer protrusions 114 can help secure the retainer 102 to the locating pin 104 and extend from the retainer base 108 in a direction away from the first body end 110. In the depicted embodiment, the retainer protrusions 114 have a substantially triangular shape. However, the retainer protrusions 114 may have other suitable shapes.

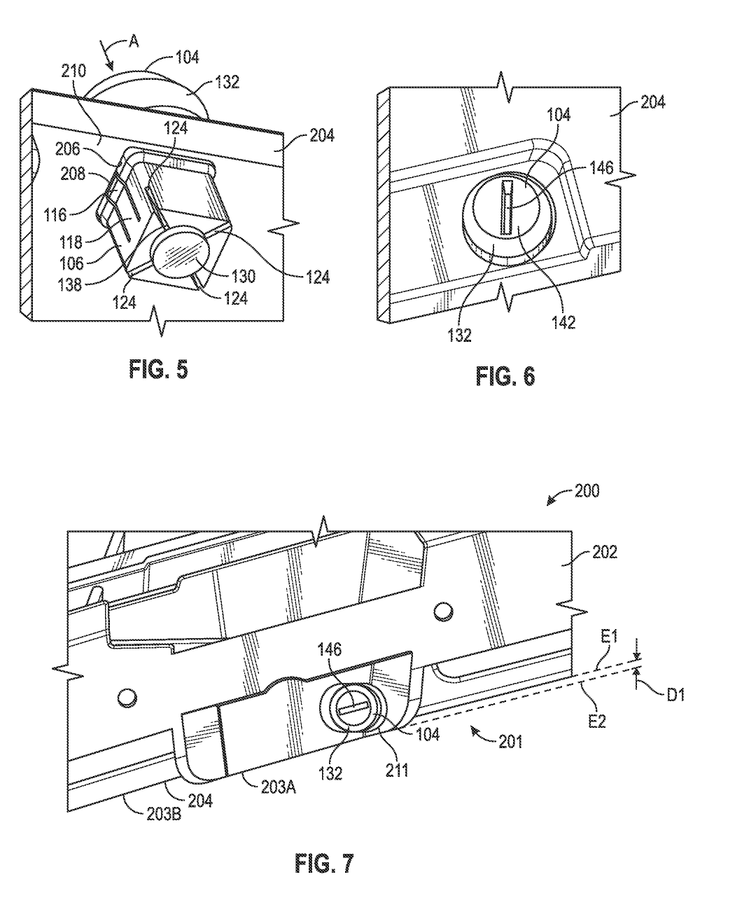

The retainer 102 further includes at least one snap fit hook 116 coupled to the retainer body 106. As a non-limiting example, the retainer 102 may include two snap fit hooks 116 located on opposite sides of the retainer body 106. Each snap fit hook 116 includes a beam 118 resiliently coupled to the retainer body 106. The beam 118 can flex outwardly (away from the retainer axis X). When the locating pin 104 is inserted into retainer body 106, beam 118 is forced outwardly by shank 130, locking the retainer body 106 into component 204. As discussed in detail above, the snap fit hook 116 maintains the retainer 102 secure to the second component 204 (FIG. 5). The retainer 102 may define grooves 120 that define the snap fit hook 116. A pair of grooves 120 defines a single snap fit hook 116.

The retainer body 106 includes a resilient section 122 closer to the first body end 110 than to the second body end 112. The resilient section 122 is capable of moving relative to the rest of the retainer body 106 away from the retainer axis X when subjected to a force. When the force is no longer applied to the resilient section 122, the resilient section 122 returns to its original shape by moving toward the retainer axis X. To achieve resiliency in the resilient section 122, the retainer 102 defines a plurality of slots 124 extending from the first body end 110 toward the second body end 112. The resilient section 122 further includes a plurality of retaining legs 126 extending from the first body end 110 in a direction substantially perpendicular from the retainer axis X. Thus, the retaining legs 126 are substantially perpendicular to the retainer body 106 in order to contact the locating pin 104. The retaining legs 126 can contact a portion of the locating pin 104 in order to secure the locating pin 104 to the retainer 102.

With reference to FIG. 4, the retainer 102 defines a retainer opening 128 configured, shaped, and sized to receive at least a portion of the locating pin 104. The retainer opening 128 may have a substantially rectangular cross-section and extends through the retainer body 106 along the retainer axis X from the first body end 110 to the second body end 112.

The locating pin 104 includes a shank 130 configured, shaped, and sized to be received in the retainer opening 128. In addition, the locating pin 104 includes a head 132 coupled to the shank 130. The shank 130 extends from the head 132 along a shank axis S. When the shank 130 is disposed in the retainer opening 128, the shank axis S and the retainer axis X are substantially aligned with each other. Accordingly, the shank 130 and the retainer body 106 are arranged coaxially aligned with respect to each other.

With reference to FIGS. 3 and 4, the shank 130 defines a first shank end 134 and a second shank end 136 opposite to the first shank end 134. The head 132 is coupled to the shank 130 at the second shank end 136. The locating pin 104 further defines a substantially annular recess 138 adjacent the first shank end 134. The substantially annular recess 138 is closer to the first shank end 134 than to the second shank end 136 and is configured, shaped, and sized to receive the retaining legs 126 in order to secure the locating pin 104 to the retainer 102.

The head 132 is configured, shaped, and sized to rest on the retainer base 108 and defines a first or bottom head surface 140 and a second or top head surface 142 opposite the first head surface 140. The first head surface 140 faces toward the shank 130, and the second head surface 142 faces away from the shank 130. The head 132 defines a plurality of head protrusions 144 extending from the first head surface 140 toward the shank 130. The head protrusions 144 are configured, shaped, and sized to mate with the retainer protrusions 114 in order to couple the locating pin 104 to the retainer 102. The head protrusions 144 are annularly arranged around the shank 130. In other words, the head protrusions 144 are annularly arranged around the shank axis S.

The shank axis S is offset from the center C of the head 132 (i.e., the head center) by an offset distance O. In particular, a head axis N intersects the center C of the head 132 and is parallel to the shank axis S and the retainer axis X when the shank 130 extends through the retainer body 106. The shank axis S is offset from the head axis N by the offset distance O. Thus, the center C of the head 132 is offset from the shank 130. Consequently, rotating the head 132 about its center C causes the shank 130 to turn about the head axis N. The head 132 defines a slot 146 configured, shaped, and sized to receive a tool, such as a screwdriver. At least part of the tool can be inserted in the slot 146 in order to rotate the head 132 about the head axis N. Alternatively or additionally, the head 132 may have a substantially hexagonal shape in order to allow a hex screw driver to engage the head 132. Further, the head 132 may have a visual reference feature to visually locate the position of the head 132 relative to another object. The visual reference feature may be, for example, an indentation.

With reference to FIGS. 5-9, the locator cam assembly 100 can be used to adjust the position of the first component 202 relative to a second component 204. The first component 202 and the second component 204 may be vehicle components. As non-limiting examples, the first component 202 may be the fascia of a vehicle, and the second component 204 may be the hood of the same vehicle. Because of tolerances during the manufacturing process, components sometimes do not align perfectly. It therefore useful to provide a locator cam assembly 100 capable of adjusting the position of one component relative to another component.

As shown in FIG. 5, the second component 204 defines a component hole 206 configured, shaped, and sized to receive at least a portion of the retainer 102. Specifically, the retainer body 106 is configured, shaped, and sized to fit tightly in the component hole 206. For example, in the depicted embodiment, the component hole 206 has a substantially rectangular shape that matches the substantially rectangular shape of the retainer body 106, thereby allowing the component hole 206 to tightly receive the retainer body 106. It is envisioned, however, that the component hole 206 and the retainer body 106 may have other suitable shapes.

To couple the retainer 102 to the second component 204, the retainer body 106 can be advanced toward the component hole 206 in the direction indicated by arrow A. The retainer 102 should be continuously advanced toward the second component 204 until at least part of the retainer body 106 is inserted through the component hole 206.

The locating pin 104 can be coupled to the retainer 102 after inserting the retainer 102 to the second component 204. To do so, the shank 130 of the locating pin 104 is inserted through the retainer opening 128. As the shank 130 is advanced through the retainer opening 128, the retaining legs 126 move outwardly (away from the retainer axis X) to allow at least a portion of the shank 130 to exit the retainer body 106. The shank 130 should be advanced through the retainer opening 128 until the retaining legs 126 are positioned in the substantially annular recess 138. The substantially annular recess 138 allows the retaining legs 126 to move to their non-deformed position. At this juncture, the retainer legs 126 exert a compressive force on the shank 130 and help couple the locating pin 104 to the retainer 102. When locating pin 104 is inserted into retainer body 106, beam 118 is force outwardly by shank 130 locking the retainer body 106 into component 204. The snap fit hook 116 maintains the retainer 102 secure to the second component 204 (FIG. 5).

The first component 202 defines a component slot 211 configured, shaped, and sized to receive the head 132 of the locating pin 104. The head 132 can be disposed in the component slot 211 before, after, or while coupling the retainer 102 to the second component 204. The component slot 211 is larger than the component hole 206 in order to accommodate the head 132. The component hole 206 is smaller than the component slot 211 because the head 132 should not pass through the second component 204.

In FIG. 7, the locating pin 104 is in a first pin position. When the locating pin 104 is in the first pin position, the locator cam assembly 100 has not adjusted the position of the first component 202 relative to the second component 204. Further, when the locating pin 104 is in the first pin position, the first component 202 is in the first component position relative to the second component 204. The locating pin 104 can be rotated about the head axis N (FIG. 4) in order to move the head 132 in a first rotational direction R1 or a second rotational direction R2. The first rotational direction R1 is opposite the second rotational direction R2. As the locating pin 104 rotates about the head axis N (FIG. 4), the head 132 turns relative to the retainer 102 about the head axis N in an indexing fashion. In particular, while the head 132 rotates, the head protrusions 144 sequentially mate with the retainer protrusions 114 in an indexing fashion in order to control the movement of the head 132 relative to the retainer 102. As the locating pin 104 rotates relative to the retainer 102, the head 132 contacts and pushes the first component 202 in a first linear direction L1 or a second linear direction L2 as discussed in detail below. The first liner direction L1 is opposite the second linear direction L2.

As discussed above, rotating the locating pin 104 causes the first component 202 to move relative to the second component 204. When locating pin 104 is in the first pin position (FIG. 7), the first component 202 is spaced from the second component 204 by a first distance D1. The first distance D1 is defined from an edge 203A of the first component 202 to an edge 203B of the second component 204. The edge 203A of the first component 202 extends along a first edge axis E1, and the edge 203B of the second component 204 extends along a second edge axis E2. The first edge axis E1 is spaced from the second edge axis E2 by the first distance D1.

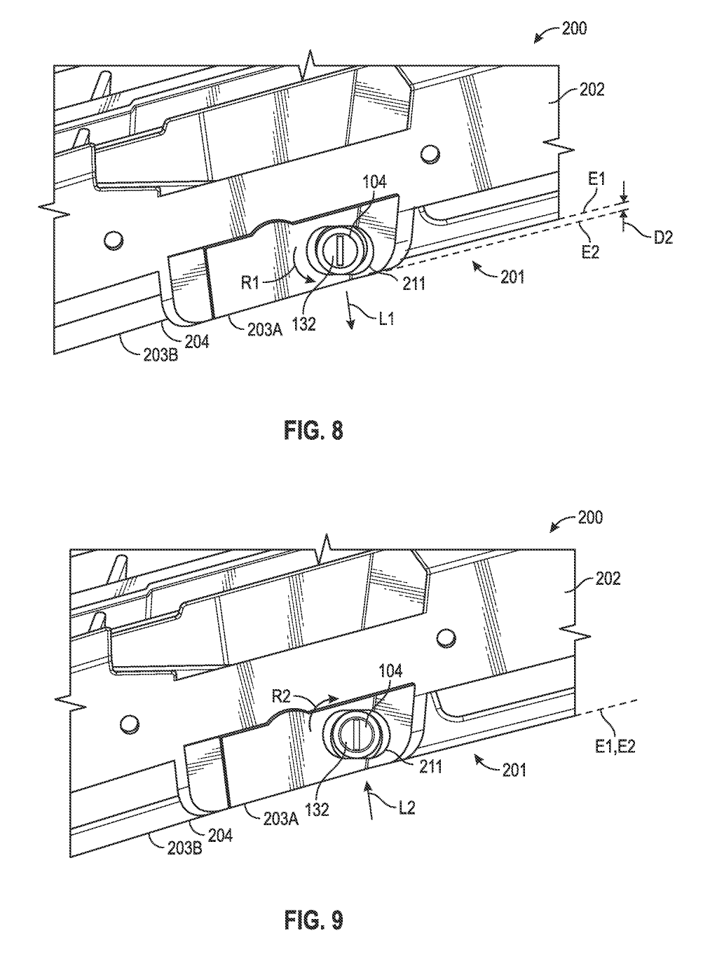

The locating pin 104 can then be rotated ninety degrees relative to the retainer 102 in the first rotational direction R1 from the first pin position (FIG. 7) to a second pin position (FIG. 8). A tool, such as a screwdriver, can be used to rotate the locating pin 104. As the locating pin 104 rotates relative to the retainer 102 in the first rotational direction R1, the head 132 contacts and urges the first component 202 to move in the first linear direction L1 away the second component position (FIG. 8). When the first component 202 is in the second component position with respect to the second component 204, the first component 202 is spaced from the second component 204 by a second distance D2. The second distance D2 is defined from the edge 203A of the first component 202 to the edge 203B of the second component 204. In the depicted embodiment, the second distance D2 is greater than the first distance D1.

The locating pin 104 can also be rotated ninety degrees relative to the retainer 102 in the second rotational direction R2 from the first pin position (FIG. 7) to a third pin position (FIG. 9). As the locating pin 104 rotates relative to the retainer 102 in the second rotational direction R2, the head 132 contacts and urges the first component 202 to move in the second linear direction L2 toward a third component position (FIG. 9). When the first component 202 is in the third component position with respect to the second component 204, the edge 203A of the first component 202 is substantially aligned with the edge 203B of the second component 204. Accordingly, the first edge axis E1 is substantially aligned with the second edge axis E2 when the first component 202 is in the third component position.

While the best modes for carrying out the teachings have been described in detail, those familiar with the art to which this disclosure relates will recognize various alternative designs and embodiments for practicing the teachings within the scope of the appended claims.

1. A component assembly, comprising:
a first component defining a component hole;
a second component defining a component slot;
a retainer including a retainer body and a retainer base coupled to the retainer body, wherein the retainer body extends through the component hole such that the retainer is coupled to the first component;
a locating pin including a head and a shank coupled to the head, wherein the head is disposed on the retainer base, the shank extends through the retainer body along a shank axis, the head defines a head center and is disposed in the component slot, and the shank axis is offset from the head center; and
wherein the locating pin is rotatable relative to the retainer about the shank axis such that rotation of the locating pin causes the first component to move relative to the second component.

2. The component assembly of claim 1, wherein the locating pin includes head protrusions extending from the head toward the shank, the retainer includes retainer protrusions extending from the retainer base away from the retainer body, and the retainer protrusions are configured to mate with the head protrusions in order to allow the head to rotate relative to the retainer base in an indexing fashion.

3. The component assembly of claim 2, wherein the head protrusions and the retainer protrusions have a triangular shape.

4. The component assembly of claim 2, wherein the retainer body extends along a retainer axis, and the retainer protrusions are annularly arranged around the retainer axis.

5. The component assembly of claim 4, wherein the head defines a head axis, the head axis intersects the head center, and the head protrusions are annularly arranged around the shank axis.

6. The component assembly of claim 5, wherein the head axis is parallel to the retainer axis and the shank axis when the shank extends through the retainer body, and the head axis is offset from the shank axis by an offset distance.

7. The component assembly of claim 1, wherein the retainer includes snap fit hooks coupled to the retainer body, and the snap fit hooks are configured to contact the second component to couple the retainer to the second component.

8. The component assembly of claim 1, wherein the component slot is larger than the component hole.

9. The component assembly of claim 1, wherein the retainer includes a plurality of retaining legs coupled to the retainer body, and the retaining legs are perpendicular to the retainer body and are configured to contact the shank in order to couple the shank to the retainer.

10. The component assembly of claim 9, wherein the retainer body defines a first body end and a second body end opposite the first body end, the retainer base is coupled to the retainer body at the second body end, and the retaining legs are coupled to the retainer body at the first body end.

11. The component assembly of claim 1, wherein the locating pin is configured to rotate relative to the retainer from a first pin position to a second pin position such that rotation of the locating pin from the first pin position to the second pin position causes the first component to move linearly away from the second component.

12. The component assembly of claim 11, wherein the first component is spaced from the second component by a first distance when the locating pin is in the first pin position, and the first component is spaced from the second component by a second distance when the locating pin is in the second pin position, and the second distance is greater than the first distance.

13. The component assembly of claim 11, wherein the locating pin is configured to rotate relative to the retainer from the first pin position to a third pin position such that rotation of the locating pin from the first pin position to the third pin position causes the first component to move linearly toward the second component.

14. A locator cam assembly, comprising:
a retainer including a retainer body and defining a retainer opening extending through the retainer body; and
a locating pin including a head and a shank extending from the head, wherein the head defines a head center and the shank extends along a shank axis, and the shank axis is offset from the head center.

15. The locator cam assembly of claim 14, wherein the locating pin includes a plurality of head protrusions extending from the head toward the shank, the retainer includes a retainer base coupled to the retainer body and a plurality of retainer protrusions extending from the retainer base away from the retainer body, and the retainer protrusions are configured to mate with the head protrusions in order to allow the head to rotate relative to the retainer base in an indexing fashion.

16. The locator cam assembly of claim 15, wherein the head protrusions and the retainer protrusions have a triangular shape.

17. The locator cam assembly of claim 15, wherein the retainer body extends along a retainer axis, and the retainer protrusions are annularly arranged around the retainer axis.

18. The locator cam assembly of claim 17, wherein the shank defines a shank axis, and the head protrusions are annularly arranged around the shank axis.

19. The locator cam assembly of claim 18, wherein the head defines a head axis, the head axis is parallel to the retainer axis and the shank axis when the shank extends through the retainer body, and the head axis is offset from the shank axis by an offset distance.

20. A vehicle, comprising:
a first vehicular component defining a component hole;
a second vehicular component defining a component slot; and
a locator cam assembly disposed between the first vehicular component and the second vehicular component, wherein the locator cam assembly includes:
a retainer including a retainer body and a retainer base coupled to the retainer body, wherein the retainer body extends through the component hole such that the retainer is coupled to the first vehicular component;
a locating pin including a head and a shank coupled to the head, wherein the head is disposed on the retainer base, the shank extends through the retainer body along a shank axis, the head defines a head center, the head is disposed in the component slot, and the shank axis is offset from the head center; and
wherein the locating pin is rotatable relative to the retainer such that rotation of the locating pin causes the first vehicular component to move relative to the second vehicular component.
